(19) United States
(12) Patent Application Publication
(10) Pub. No.: US 2013/0105256 A1
(43) Pub. Date: May 2, 2013

(54) ELECTRIC PARKING BRAKE

(71) Applicant: MANDO CORPORATION, Gyeonggi-do (KR)

(72) Inventor: Moo Kang SON, Busan (KR)

(73) Assignee: MANDO CORPORATION, Gyeonggi-do (KR)

(21) Appl. No.: 13/667,435

(22) Filed: Nov. 2, 2012

(30) Foreign Application Priority Data
Nov. 2, 2011 (KR) 10-2011-0113092

(51) Int. Cl. B60T 7/02

(52) U.S. Cl. 188/156

(57) ABSTRACT

Disclosed is an electric parking brake (EPB) including a housing, a parking cable connected to brakes, a motor to generate driving force to drive the parking cable, a reduction gear unit connected to a rotating shaft of the motor, a screw-nut unit including a screw member, a nut member screw-coupled to the screw member and a gear member mounted on an outer surface of the nut member, and a displacement sensor connected to an end of the nut member to detect a magnitude of force applied to the parking cable. The parking cable includes a first parking cable connected to an end of the screw member, and a second parking cable connected to an end of the displacement sensor when a dual puller type is applied. The end of the displacement sensor is connected to a fixing cable fastened to the housing when a single puller type is applied.

### CROSS-REFERENCE TO RELATED APPLICATION(S)

This application claims the benefit of Korean Patent Application No. P2011-113092, filed on Nov. 2, 2011 in the Korean Intellectual Property Office, the disclosure of which is incorporated herein by reference.

### BACKGROUND

1. Field

Embodiments of the present invention relate to an electric parking brake of a cable puller type to which both a single puller type and a dual puller type are applicable.

2. Description of the Related Art

An electric parking brake (EPB) is generally adapted to apply braking force to wheels of a vehicle to prevent the wheels from rotating such that the vehicle remains stopped when parked.

EPBs are classified into a cable puller type and a motor on caliper type. EPBs of the cable puller type are further classified into a single puller type and a dual puller type. An EPB of the single puller type is more easily installed in a vehicle than an EPB of the dual puller type.

In conventional cases, applying both the single puller type and the dual puller type to the EPB of the cable puller type may be limited.

### SUMMARY

Accordingly, it is an aspect of the present invention to provide an EPB to which both a single puller type and a dual puller type are applicable.

Additional aspects of the invention will be set forth in part in the description which follows and, in part, will be obvious from the description, or may be learned by practice of the invention.

In accordance with one aspect of the present invention, an EPB includes a housing, a parking cable connected to brakes which apply braking force to wheels of a vehicle, a motor to generate driving force to drive the parking cable, a reduction gear unit connected to a rotating shaft of the motor to allow power to be transmitted, a screw-nut unit including a screw member, a nut member screw-coupled with the screw member, and a gear member mounted on an outer surface of the nut member to engage with gears of the reduction gear unit, and a displacement sensor connected to an end of the nut member to detect a magnitude of force applied to the parking cable by operation of the screw-nut unit.

The parking cable includes a first parking cable connected to an end of the screw member, and a second parking cable connected to an end of the displacement sensor when a dual puller type is applied to the EPB.

When a single puller type is applied to the EPB, the end of the displacement sensor is connected to a fixing cable in place of the second parking cable. The fixing cable may be fastened to an end of the housing facing the displacement sensor.

When the screw member is moved by the driving force of the motor, the nut member is moved in an opposite direction to the movement of the screw member by a displacement equal to a displacement of the screw member.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view illustrating an EPB according to an embodiment of the present invention, in which a dual puller type is applied to the EPB; and

FIG. 2 is a view illustrating an EPB according to another embodiment of the present invention, in which a single puller type is applied to the EPB.

### DETAILED DESCRIPTION

Reference will now be made in detail to the embodiments of the present invention, examples of which are illustrated in the accompanying drawings. It should be understood that the terms used in the specification and appended claims should not be construed as limited to general and dictionary meanings but should be construed based on the meanings and concepts according to the spirit of the present invention on the basis of the principle that the inventor is permitted to define appropriate terms for best explanation. The preferred embodiments described in the specification and shown in the drawings are only illustrative and are not intended to represent all aspects of the invention, such that various equivalents and modifications may be made without departing from the spirit of the invention.

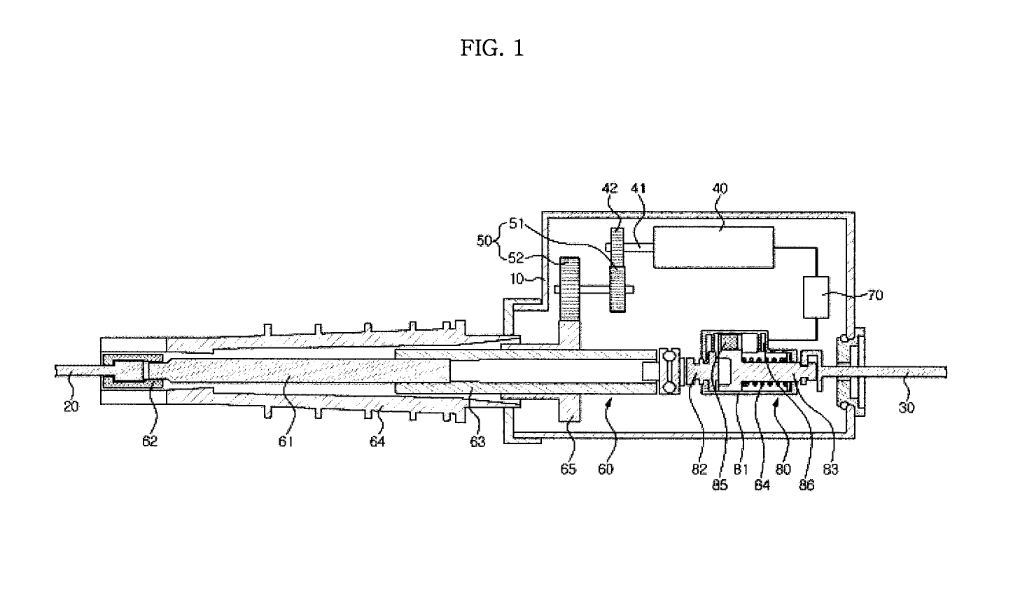

As shown in FIG. 1, an electric parking brake EPB of the present invention includes a housing 10 forming an external appearance of the EPB, first and second parking cables 20 and 30 connected to brakes which apply braking force to wheels of the vehicle, a motor 40 to generate driving force to drive the parking cables 20 and 30, a reduction gear unit 50 connected to a rotating shaft 41 of the motor 40 to allow power to be transmitted, a screw-nut unit 60 engaged with the reduction gear 50, and a control unit 70 to control the motor 40.

The motor 40 is powered by electricity applied thereto from an external source of electricity. The motor 40 is provided with the rotating shaft 41, which is integrated with a drive gear 42.

In FIG. 1, the reduction gear 50 includes a first gear 51 engaged with the drive gear 42, and a second gear 52 engaged with a gear member 65 of the screw-nut unit 60, which will be described below, to rotate according to rotation of the first gear 51.

In the present embodiment, the reduction gear unit 50 may employ various gear assemblies, in addition to a spur gear assembly, such as a planetary gear assembly which may reduce the driving force of the motor 40, as shown in FIG. 1.

The screw-nut unit 60 operates, interlocked with the reduction gear unit 50, to pull or release the first and second parking cables 20 and 30. The screw-nut unit 60 includes a screw member 61, a nut member 63 screw-coupled with the screw member 61, and a gear member 65 mounted on an outer surface of the nut member 63.

One end of the screw member 61 is connected to the first parking cable 20 through a first connection member 62. The screw member 61 is screw-coupled with the nut member 63, as described above. To this end, an external thread is formed on an outer surface of the screw member 61.

In addition, an internal thread is formed on an inner surface of the nut member 63 so that the nut member 63 may be screw-coupled with the screw member 61. A displacement sensor 80 is connected to one end of the nut member 63 opposite to the screw member 61 inserted into the nut member 63, as shown in FIG. 1.

As described above, the gear member 65 is mounted on the outer surface of the nut member 63 and is engaged with the second gear 52 of the reduction gear unit 50 to receive the driving force of the motor 40 transmitted thereto through the reduction gear unit 50.

Reference numeral 64 indicates a housing of the screw-nut unit 60, which accommodates the screw member 61 formed to protrude from the housing 10.

The displacement sensor 80 detects magnitude of force applied to the first and second parking cables 20 and 30 by operation of the screw-nut unit 60 and transmits a signal representing the detected magnitude to the control unit 70. The displacement sensor 80 includes a sensor housing 81, a sensor latch 82, a magnet housing 83, a magnetoelastic member 84, a magnet 85 and a Hall IC 86.

As shown in FIG. 1, the sensor latch 82 is arranged to partially protrude from one end of the sensor housing 81 and is connected to the other end of the nut member 63 to move according to movement of the nut member 63.

The magnet housing 83 is arranged to be movable in the sensor housing 81 and is elastically supported by the magnetoelastic member 84. The magnet housing 83 is arranged to partially protrude from the other end of the sensor housing 81, and the second parking cable 30 is connected to a portion of the magnet housing 83 protruded from the other end of the sensor housing 81. In addition, the magnet housing 83 is moved by repulsive force of the nut member 63 caused by movement of the screw member 61.

The magnet 85 is provided at one side of the magnet housing 83, and the Hall IC 86 detects variation of magnetic field according to movement of the magnet 85 and transmits an electric signal representing the variation to the control unit 70.

That is, according to the illustrated embodiment of the present invention, as the nut member 63 is driven by the rotational force of the motor 40, the sensor housing 81 is moved by the sensor latch 82, and the relative displacement between the sensor housing 81 and the magnet housing 83 is detected using the magnet 85 and the Hall IC 86.

The control unit 70 controls various operations of the motor 40 such as starting and stopping, and forward rotation and reverse rotation, based on a command from a driver and the electric signals transmitted thereto from the displacement sensor 80.

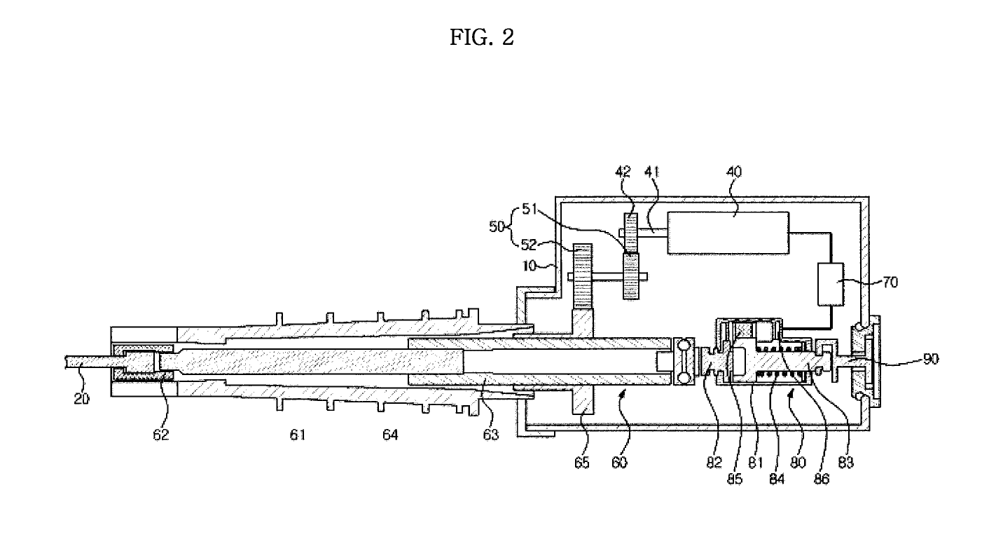

In addition to the dual puller type shown in FIG. 1, a single puller type is also applicable to the EPB of the present invention as shown in FIG. 2. Hereinafter, the EPB to which the single puller type is applied will be described with reference to FIG. 2, and a detailed description of the elements shared by the dual puller type will thus be omitted.

As shown in FIG. 2, in order to apply the single puller type to the ESB, the displacement sensor 80 is fixed to the housing 10. To this end, a fixing cable 90 is connected between facing ends of the magnet housing 83 of the displacement sensor 80 and the housing 10. That is, the single puller type is applied to the EPB by fixing the displacement sensor 80 to the housing 10 through the fixing cable 90.

Hereinafter, operation of the EPB according to embodiments of the present invention will be described with reference to the accompanying drawings.

If a command to operate the brake is issued through the control unit 70, the motor 40 rotates in a predetermined direction, for example, in the normal direction. As the motor 40 rotates, the reduction gear unit 50 is rotated by the drive gear 42. Then the reduction gear unit 50 rotates the gear member 65 and the nut member 63 of the screw-nut unit 60.

When the nut member 63 rotates, the external thread of the screw member 61 screw-coupled with the internal thread of the nut member 63 is inserted into the internal thread to pull the first parking cable 20 connected to one end of the screw member 61.

At the same time, the nut member 63 moves in the opposite direction to the movement of the screw member 61 by a displacement equal to a displacement of the screw member 61 and causes the second parking cable 30 connected to the other end of the displacement sensor 80 to be pulled.

As the first and second parking cables 20 and 30 are driven, the brakes coupled respectively to the first and second parking cables 20 and 30 are operated to apply braking force to the wheels.

When the single puller type is applied to the EPB, the displacement sensor 80 is fixed to the other end of the housing 10 through the fixing cable 90, so that only the first parking cable 20 may be pulled.

Therefore, according to the embodiments of the present invention, the single puller type or the dual puller type may be determined to be applied to the EPB by connecting the second parking cable or the fixing cable to an end of the displacement sensor 80, and accordingly both the single puller type and the dual puller type are applicable to the EPB.

As is apparent from the above description, both the dual puller type and the single puller type are applicable to the EPB according to the embodiments of the present invention in such a way that when the dual puller type is applied to the EPB, the second parking cable is connected to an end of the displacement sensor, and when the single puller type is applied to the EPB, the end of the displacement sensor is connected to a fixing cable, which is fastened to the housing, in place of the second parking cable.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electric parking brake (EPB) to park a vehicle, comprising:
a housing;
a parking cable connected to brakes which apply braking force to wheels of the vehicle;
a motor to generate driving force to drive the parking cable;
a reduction gear unit connected to a rotating shaft of the motor to allow power to be transmitted;
a screw-nut unit comprising:
a screw member;
a nut member screw-coupled to the screw member; and
a gear member mounted on an outer surface of the nut member to be engaged with gears of the reduction gear unit; and
a displacement sensor connected to an end of the nut member to detect a magnitude of force applied to the parking cable by operation of the screw-nut unit,
wherein the parking cable comprises a first parking cable connected to an end of the screw member, and a second parking cable connected to an end of the displacement sensor when a dual puller type is applied to the EPB,
wherein the end of the displacement sensor is connected to a fixing cable in place of the second parking when a single puller type is applied to the EPB,
wherein the fixing cable is fastened to an end of the housing facing the displacement sensor.

2. The EPB according to claim 1, wherein, when the screw member is moved by the driving force generated by the motor, the nut member is moved in an opposite direction to the movement of the screw member by a displacement equal to a displacement of the screw member.
